(19) United States
(12) Patent Application Publication
(10) Pub. No.: US 2022/0195754 A1
(43) Pub. Date: Jun. 23, 2022

(54) Electronic Lock Cylinder

(71) Applicant: Jeff Chen, Chiayi City (TW)

(72) Inventor: Jeff Chen, Chiayi City (TW)

(21) Appl. No.: 17/128,495

(22) Filed: Dec. 21, 2020

(51) Int. Cl. E05B 47/00

(52) U.S. Cl. CPC E05B 47/0012; E05B 2047/0037; E05B 2047/0026; E05B 2047/0017

(57) ABSTRACT

An electronic lock cylinder contains: a receiving sleeve, a lock head, a fastener, a rotation element, a rotatable actuation element, a driven element, a drive motor, a resilient element, an operation element, a locking element, and a locating cap. Thereby, the drive motor moves clockwise or counterclockwise to drive the rotary column to rotate 90 degrees and to simultaneously actuate the driven element, the drive motor, the resilient element, and the engagement projection of the operation element to move forward or backward to rotate or rotate idly in the notch of the locking element, thus saving energy and obtaining environmental protection.

### BACKGROUND OF THE INVENTION

### Field of the Invention

The present invention relates to an electronic lock cylinder which reduces gears and transmission elements to decrease power consumption, thus saving energy and obtaining environmental protection.

### Description of the Prior Art

A conventional electronic lock cylinder contains many gears configured to drive the electronic lock cylinder, thus causing power consumption greatly and environmental damage.

The present invention has arisen to mitigate and/or obviate the afore-described disadvantages.

### SUMMARY OF THE INVENTION

The primary object of the present invention is to provide an electronic lock cylinder which contains: a receiving sleeve, a lock head, a fastener, a rotation element, a rotatable actuation element, a driven element, a drive motor, a resilient element, an operation element, a locking element, and a locating cap.

Thereby, the drive motor moves clockwise or counterclockwise to drive the rotary column to rotate 90 degrees and to simultaneously actuate the driven element, the drive motor, the resilient element, and the engagement projection of the operation element to move forward or backward to rotate or rotate idly in the notch of the locking element, thus saving energy and obtaining environmental protection.

### BRIEF DESCRIPTION OF THE DRAWINGS

FIG. 1 is a perspective view showing the assembly of an electronic lock cylinder according to a preferred embodiment of the present invention.

FIG. 2 is a perspective view showing the exploded components of the electronic lock cylinder according to the preferred embodiment of the present invention.

FIG. 3 is another perspective view showing the exploded components of the electronic lock cylinder according to the preferred embodiment of the present invention.

FIG. 4 is a perspective view showing the assembly of a part of the electronic lock cylinder according to the preferred embodiment of the present invention.

FIG. 5 is another perspective view showing the assembly of a part of the electronic lock cylinder according to the preferred embodiment of the present invention.

FIG. 6 is a side plan view showing the operation of the electronic lock cylinder according to the preferred embodiment of the present invention.

FIG. 7 is a cross sectional view taken along the line a-a of FIG. 6.

FIG. 8 is a cross sectional view taken along the line b-b of FIG. 6.

FIG. 9 is a side plan view showing the operation of the electronic lock cylinder according to the preferred embodiment of the present invention.

FIG. 10 is a cross sectional view taken along the line c-c of FIG. 9.

FIG. 11 is a cross sectional view taken along the line d-d of FIG. 9.

FIG. 12 is a perspective view showing the operation of the electronic lock cylinder according to the preferred embodiment of the present invention.

FIG. 13 is a side plan view showing the application of the electronic lock cylinder according to the preferred embodiment of the present invention.

FIG. 14 is another side plan view showing the application of the electronic lock cylinder according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

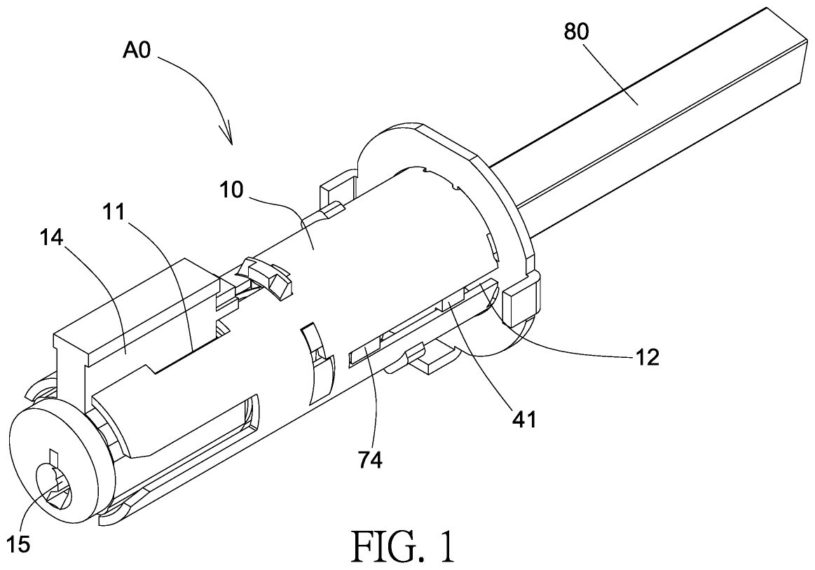

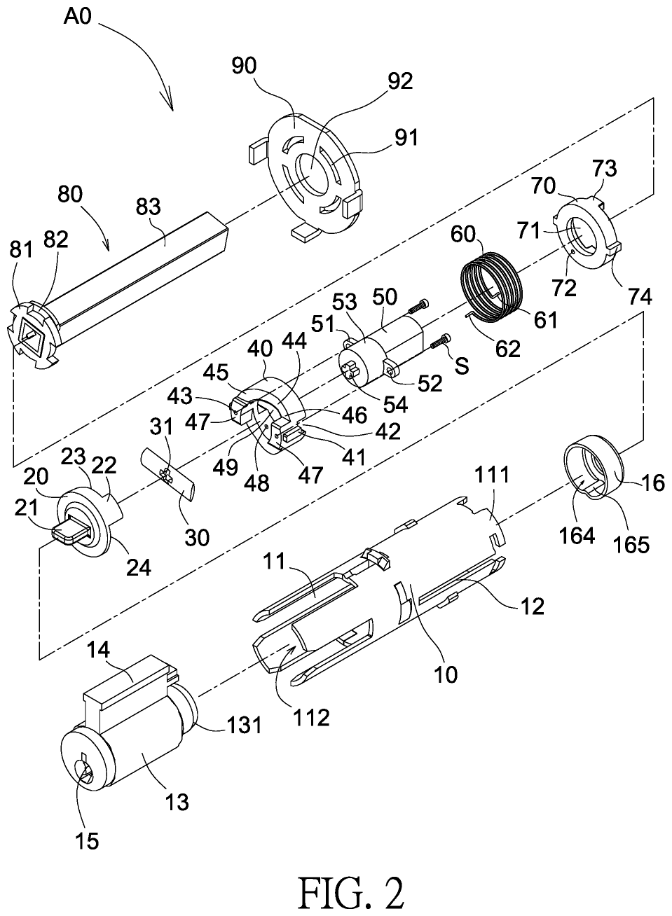

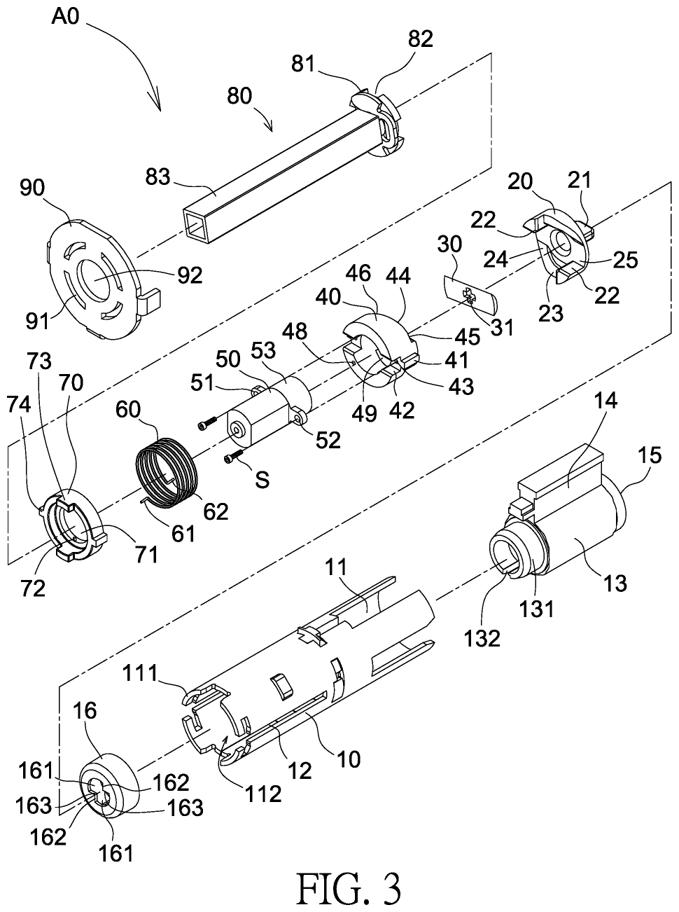

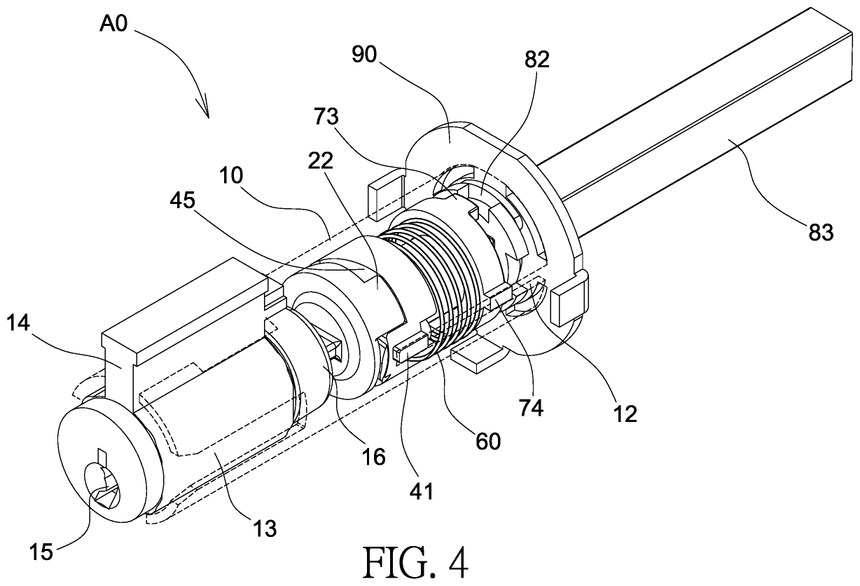

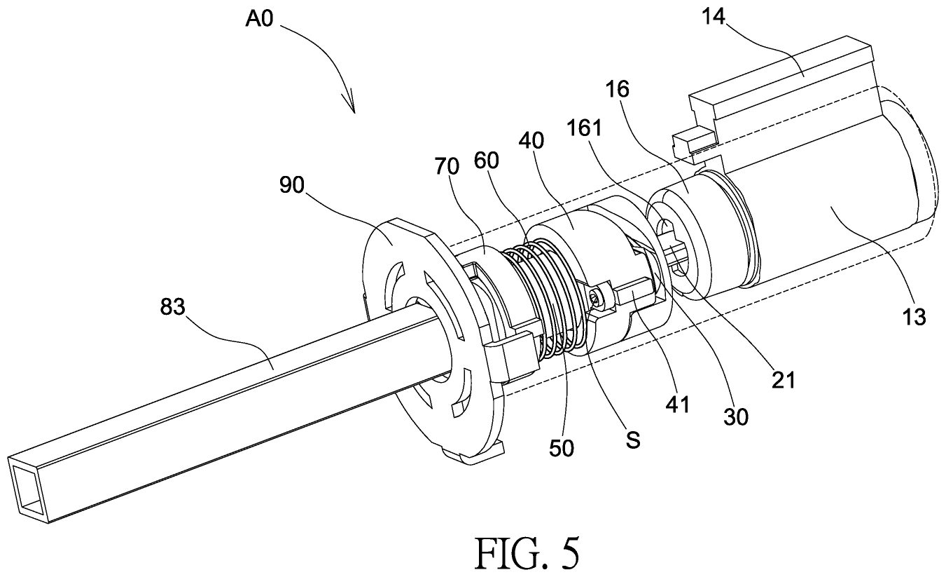

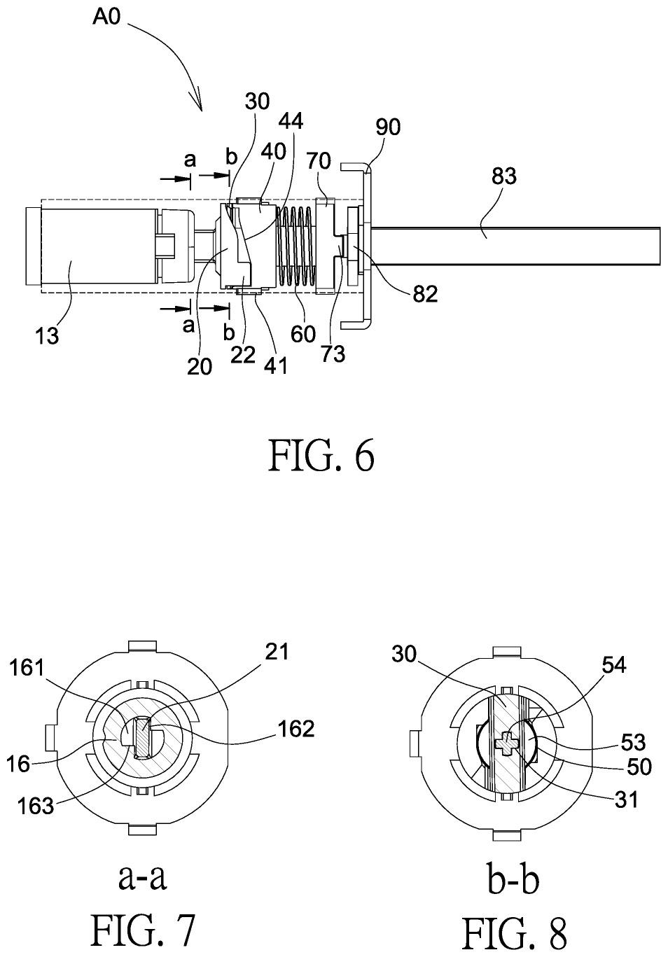

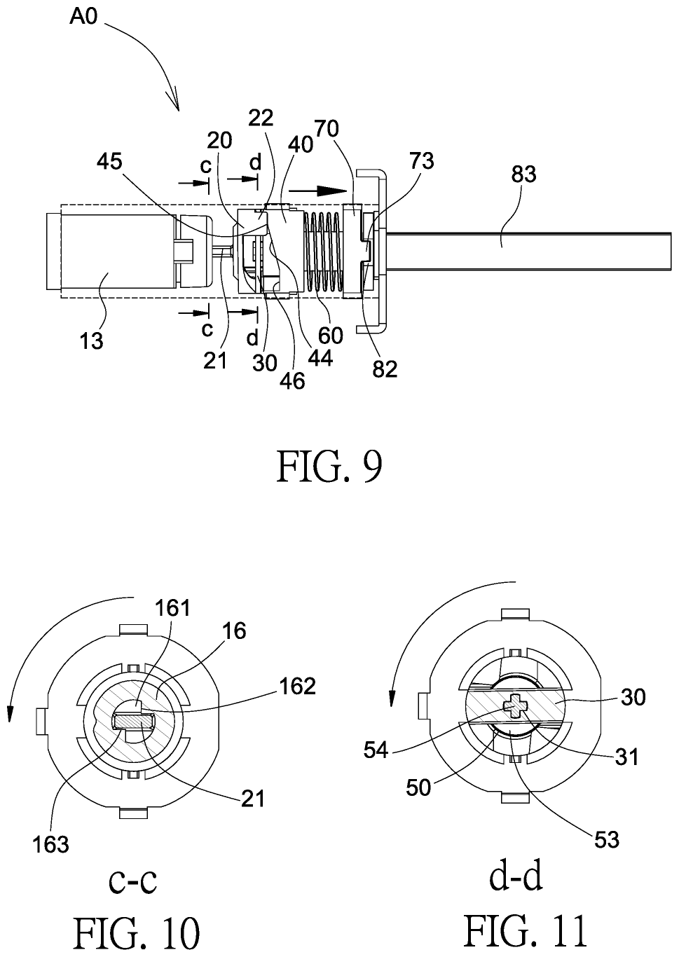

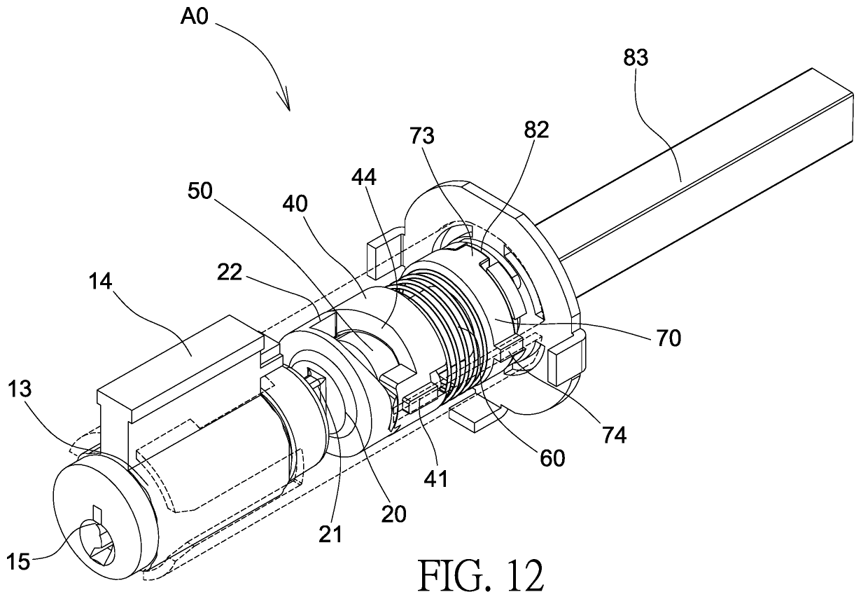

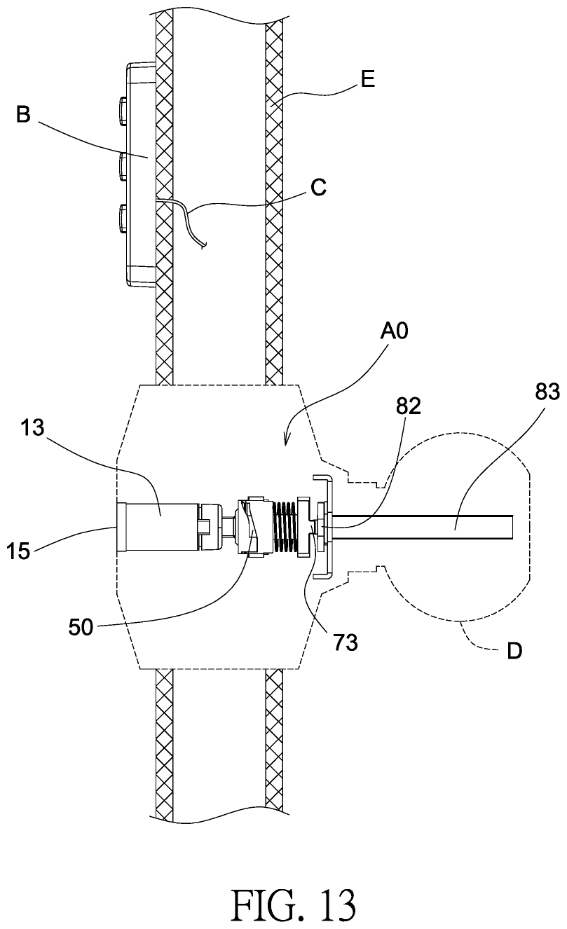

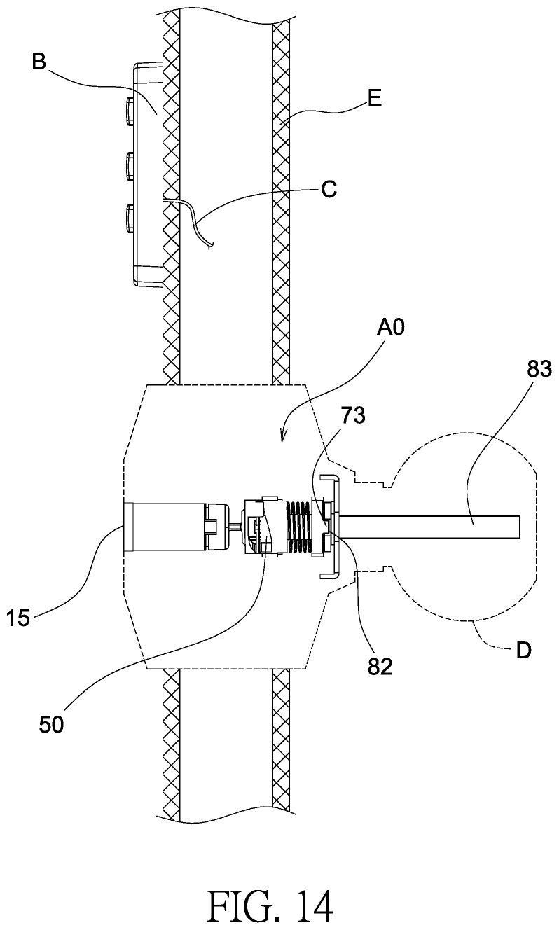

With reference to FIGS. 1-14, an electronic lock cylinder AO according to a preferred embodiment of the present invention comprises:

a receiving sleeve 10 including a hollow chamber 112 defined in the receiving sleeve 10, two linear slots 12 formed on two sides of the receiving sleeve 10, a groove 11 defined on a first end of the receiving sleeve 10, and at least one engagement segment 111 formed on a second end of the receiving sleeve 10;

a lock head 13 accommodated in an end of the hollow chamber 112 of the receiving sleeve 10, and the lock head 13 including a locking orifice 15 defined on a first end of the lock head 13, a retainer 14 formed on a top of the lock head 13 and engaged in the groove 11 of the receiving sleeve 10, a retaining segment 131 extending from a second end of the lock head 13, and a dented portion 132 formed on a peripheral side of the retaining segment 131;

a fastener 16 received in the hollow chamber 112 of the receiving sleeve 10, and the fastener 16 including a fitting orifice 164 defined on a first end of the fastener 16, a projected portion 165 formed on a peripheral side of the fitting orifice 164, such that the fitting orifice 164 is fitted on the retaining segment 131 of the lock head 13, and the projected portion 165 is engaged in the dented portion 132 of the lock head 13, the fastener 16 including two rotating orifices 161 defined on and passing through a second end of the fastener 16, wherein the two rotating orifices 16 are in communication with and at 90 degrees to each other, and the fastener 16 further including a horizontal stop portion 163 defined between two opposite horizontal positions of the two rotating orifices 161, and a vertical stop portion 162 formed between two opposite vertical positions of the two rotating orifices 161;

a rotation element 20 accommodated in the hollow chamber 112 of the receiving sleeve 10 and fixed on a side of the fastener 16, and the rotation element 20 including a rotatable guide sheet 21 corresponding to and inserted into the two rotating orifices 161 of the fastener 16 so as to move 90 degrees, wherein the rotatable guide sheet 21 is rotatably moved to stop the horizontal stop portion 163 laterally or to stop the vertical stop portion 162 longitudinally; the rotation element 20 further including two drive protrusions 22 extending from an end of the rotation element 20 opposite to the rotatable guide sheet 21, wherein the two drive protrusions 22 are at 90 degrees to each other, and the rotation element 20 including a lateral panel 25 defined between the two drive protrusions 22, two first tilted faces 23 formed on the lateral panel 25 opposite to the two drive protrusions 22 and at 90 degrees to each other, and two second tilted faces 24 at 90 degrees to each other and abut to the two first tilted faces 23;

a rotatable actuation element 30 received in the hollow chamber 112 of the receiving sleeve 10, fixed on a side of the rotation element 20, and configured to drive the rotation element 20 to rotate toward the first tilted face 23 from the lateral panel 25 via the second tilted face 24 or toward the lateral panel 25 from the first tilted face 23 via the second tilted face 24; wherein the rotatable actuation element 30 further includes a central orifice 31 defined and passing through a center thereof;

a driven element 40 accommodated in the hollow chamber 112 of the receiving sleeve 10 and mounted on a side of the rotatable actuation element 30, the driven element 40 including a hollow portion 49, two guiding rails 41 extending on two sides of the driven element 40, wherein a respective guiding rail 41 is linearly fitted in a respective linear slot 12, the driven element 40 further includes two actuated projections 47 at 90 degrees to each other, a beveled face 44 defined between the two actuated projections 47, two deep sloped surfaces 45 formed on the beveled face 44 opposite to the two actuated projections 47 and at 90 degrees to each other, two shallow sloped surfaces 46 at 90 degrees to each other and abut to the two deep sloped surfaces 45; the driven element 40 including two trenches 42 defined on two sides of the other end of the driven element 40, two threaded orifices 43 defined on the two trenches 42, and a first fixing orifice 48 defined on a predetermined position of another end surface of the driven element 40;

a drive motor 50 accommodated in the hollow chamber 112 of the receiving sleeve 10 and mounted on a side of the driven element 40, the drive motor 50 including a driving segment 53 formed on an end of the drive motor 50 and inserted into the hollow portion 49 of the driven element 40, two connection seats 51 corresponding to and accommodated in the two trenches 42 of the driven element 40, two screwing orifices 52 defined on two centers of the two connection seats 51 and screwed with the two threaded orifices 43 of the driven element 40 via a screw bolt S, a rotary column 54 extending from an end of the driving segment 53 and connected with the central orifice 31 of the rotatable actuation element 30 so that the drive motor 50 drives the rotatable actuation element 30 to rotate 90 degrees clockwisely or counterclockwise via the rotary column 54;

a resilient element 60 received in the hollow chamber 112 of the receiving sleeve 10 and corresponding to the drive motor 50, the resilient element 60 including a first positioning segment 62 and a second positioning segment 61 which are formed on two free ends of the resilient element 60, and the first positioning segment 62 being accommodated in the first fixing orifice 48 of the driven element 40;

an operation element 70 received in the hollow chamber 112 of the receiving sleeve 10 and corresponding to the resilient element 60, the operation element 70 including a second positioning orifice 72 defined on a predetermined position of the operation element 70 and connected with the second positioning segment 61 of the resilient element 60, a hollow cavity 71 defined on a center of the operation element 70 so that the drive motor 50 movably inserts in the hollow cavity 71, two racks 74 formed on two peripheral sides of the operation element 70 and linearly fitted in the two linear slots 12 of the receiving sleeve 10; and the operation element 70 further including an engagement projection 73 extending from one of the two peripheral sides of the operation element 70;

a locking element 80 disposed on the other side of the receiving sleeve 10 abut to the operation element 70, the locking element 80 including a retaining segment 81 formed on a first end of the locking element 80, a notch 82 defined on a predetermined position of the retaining segment 81, wherein the notch 80 normally keeps a distance from the engagement projection 73 of the operation element 70; the locking element 80 further including a lock portion 83 formed on a second end of the locking element 80;

a locating cap 90 fixed on the other side of the receiving sleeve 10 and corresponding to the locking element 80, the locating cap 90 including a coupling aperture 92 defined on a center of the locating cap 90 and configured to accommodate the lock portion 83 of the locking element 80, and the retaining segment 81 of the locking element 80 is fixed in the coupling aperture 92, wherein the locating cap 90 further including at least one trough 91 configured to engage with the at least one engagement segment 111 of the receiving sleeve 10.

The rotary column 54 of the drive motor 50 has an end surface formed in a cross shape, and the central orifice 31 of the rotatable actuation element 30 is formed in a cross shape so as to correspond to the end surface of the rotary column 54.

The electronic lock cylinder is applicable for a horn lock D of a door panel E, the drive motor 50 matches with a signal line C of an electronic lock B, for example, when the lock head 13 faces the door panel E outward, the drive motor 50 drives the rotary column 54 to rotate 90 degrees clockwise or counterclockwise, such that the rotatable actuation element 30 is driven to actuate the rotation element 20 to rotate 90 degrees clockwise or counterclockwise. When the rotation element 20 rotates clockwise, the rotatable actuation element 30 is located on the two shallow sloped surfaces 46 of the driven element 40, and the driven element 40, the drive motor 50, the resilient element 60, and the engagement projection 73 of the operation element 70 keep a distance from the notch 82, after the driven element 40, the drive motor 50, the resilient element 60, and the engagement projection 73 move backward, hence the driven element 40, the drive motor 50, the resilient element 60, and the engagement projection 73 do not engage in the notch 82 of the locking element 80 so that the horn lock D, which corresponding to the locking element 80, rotates idly. When the rotation element 20 rotates counterclockwise, the rotatable actuation element 30 is located on the two deep sloped surfaces 45 of the driven element 40, and the driven element 40, the drive motor 50, the resilient element 60, and the engagement projection 73 of the operation element 70 move and engage in the notch 82, after the driven element 40, the drive motor 50, the resilient element 60, and the engagement projection 73 move forward, hence the horn lock D, which corresponding to the locking element 80, rotates.

Thereby, the drive motor 50 moves clockwise or counterclockwise to drive the rotary column 54 to rotate 90 degrees and to simultaneously actuate the driven element 40, the drive motor 50, the resilient element 60, and the engagement projection 73 of the operation element 70 to move forward or backward to rotate or rotate idly in the notch 82 of the locking element 80, thus saving energy and obtaining environmental protection.

While various embodiments in accordance with the present invention have been shown and described, it is clear to those skilled in the art that further embodiments may be made without departing from the scope of the present invention.

What is claimed is:

1. An electronic lock cylinder comprising:
a receiving sleeve including a hollow chamber defined in the receiving sleeve, two linear slots formed on two sides of the receiving sleeve, a groove defined on a first end of the receiving sleeve, and at least one engagement segment formed on a second end of the receiving sleeve;
a lock head accommodated in an end of the hollow chamber of the receiving sleeve, and the lock head including a locking orifice defined on a first end of the lock head, a retainer formed on a top of the lock head and engaged in the groove of the receiving sleeve, a retaining segment extending from a second end of the lock head, and a dented portion formed on a peripheral side of the retaining segment;
a fastener received in the hollow chamber of the receiving sleeve, and the fastener including a fitting orifice defined on a first end of the fastener, a projected portion formed on a peripheral side of the fitting orifice, such that the fitting orifice is fitted on the retaining segment of the lock head, and the projected portion is engaged in the dented portion of the lock head, the fastener including two rotating orifices defined on and passing through a second end of the fastener, wherein the two rotating orifices are in communication with and at 90 degrees to each other, and the fastener further including a horizontal stop portion defined between two opposite horizontal positions of the two rotating orifices, and a vertical stop portion formed between two opposite vertical positions of the two rotating orifices;
a rotation element accommodated in the hollow chamber of the receiving sleeve and fixed on a side of the fastener, and the rotation element including a rotatable guide sheet corresponding to and inserted into the two rotating orifices of the fastener so as to move 90 degrees, wherein the rotatable guide sheet is rotatably moved to stop the horizontal stop portion laterally or to stop the vertical stop portion longitudinally; the rotation element further including two drive protrusions extending from an end of the rotation element opposite to the rotatable guide sheet, wherein the two drive protrusions are at 90 degrees to each other, and the rotation element including a lateral panel defined between the two drive protrusions, two first tilted faces formed on the lateral panel opposite to the two drive protrusions and at 90 degrees to each other, and two second tilted faces at 90 degrees to each other and abut to the two first tilted faces;
a rotatable actuation element received in the hollow chamber of the receiving sleeve, fixed on a side of the rotation element, and configured to drive the rotation element to rotate toward the first tilted face from the lateral panel via the second tilted face or toward the lateral panel from the first tilted face via the second tilted face; wherein the rotatable actuation element further includes a central orifice defined and passing through a center thereof;
a driven element accommodated in the hollow chamber of the receiving sleeve and mounted on a side of the rotatable actuation element, the driven element including a hollow portion, two guiding rails extending on two sides of the driven element, wherein a respective guiding rail is linearly fitted in a respective linear slot, the driven element further includes two actuated projections at 90 degrees to each other, a beveled face defined between the two actuated projections, two deep sloped surfaces formed on the beveled face opposite to the two actuated projections and at 90 degrees to each other, two shallow sloped surfaces at 90 degrees to each other and abut to the two deep sloped surfaces; the driven element including two trenches defined on two sides of the other end of the driven element, two threaded orifices defined on the two trenches, and a first fixing orifice defined on a predetermined position of another end surface of the driven element;
a drive motor accommodated in the hollow chamber of the receiving sleeve and mounted on a side of the driven element, the drive motor including a driving segment formed on an end of the drive motor and inserted into the hollow portion of the driven element, two connection seats corresponding to and accommodated in the two trenches of the driven element, two screwing orifices defined on two centers of the two connection seats and screwed with the two threaded orifices of the driven element via a screw bolt, a rotary column extending from an end of the driving segment and connected with the central orifice of the rotatable actuation element so that the drive motor drives the rotatable actuation element to rotate 90 degrees clockwisely or counterclockwise via the rotary column;
a resilient element received in the hollow chamber of the receiving sleeve and corresponding to the drive motor, the resilient element including a first positioning segment and a second positioning segment which are formed on two free ends of the resilient element, and the first positioning segment being accommodated in the first fixing orifice of the driven element;
an operation element received in the hollow chamber of the receiving sleeve and corresponding to the resilient element, the operation element including a second positioning orifice defined on a predetermined position of the operation element and connected with the second positioning segment of the resilient element, a hollow cavity defined on a center of the operation element so that the drive motor movably inserts in the hollow cavity, two racks formed on two peripheral sides of the operation element and linearly fitted in the two linear slots of the receiving sleeve; and the operation element further including an engagement projection extending from one of the two peripheral sides of the operation element;
a locking element disposed on the other side of the receiving sleeve abut to the operation element, the locking element including a retaining segment formed on a first end of the locking element, a notch defined on a predetermined position of the retaining segment, wherein the notch normally keeps a distance from the engagement projection of the operation element; the locking element further including a lock portion formed on a second end of the locking element;
a locating cap fixed on the other side of the receiving sleeve and corresponding to the locking element, the locating cap including a coupling aperture defined on a center of the locating cap and configured to accommodate the lock portion of the locking element, and the retaining segment of the locking element is fixed in the coupling aperture, wherein the locating cap further including at least one trough configured to engage with the at least one engagement segment of the receiving sleeve.

2. The electronic lock cylinder as claimed in claim 1, wherein the rotary column of the drive motor has an end surface formed in a cross shape, and the central orifice of the rotatable actuation element is formed in a cross shape so as to correspond to the end surface of the rotary column.
